(19) United States
(12) Patent Application Publication
(10) Pub. No.: US 2011/0052351 A1
(43) Pub. Date: Mar. 3, 2011

(54) AUTOMATED PARCEL DELIVERY SYSTEM

(76) Inventor: Randall L. Voelker, Newton, KS (US)

(21) Appl. No.: 12/549,090

(22) Filed: Aug. 27, 2009

(51) Int. Cl. B65G 49/00; E05B 65/00

(52) U.S. Cl. 414/289; 70/91

(57) ABSTRACT

This invention relates generally to tube delivery systems and, more particularly, to an automatic parcel delivery system with security measures. Tube delivery systems are known in the prior art and are widely used by banks and pharmacies to consummate transactions. Other tube delivery systems are used to convey materials within large buildings. The existing tube delivery systems are not well suited to deliver parcels securely and efficiently in a residential environ. The present invention discloses an apparatus for delivering parcels securely and efficiently in a residential environment.

### BACKGROUND OF THE INVENTION

1. Field of the Invention

This invention relates generally to tube delivery systems and, more particularly, to an automatic parcel delivery system with security measures.

2. Description of Related Art

Tube delivery systems are known in the prior art and are widely used by banks and pharmacies to consummate transactions. Other tube delivery systems are used to convey materials within large buildings. The existing tube delivery systems are not well suited to deliver parcels securely and efficiently in a residential environ. The present invention discloses an apparatus for delivering parcels securely and efficiently in a residential environment.

### BRIEF SUMMARY OF THE INVENTION

The present invention discloses an apparatus for delivering parcels securely and efficiently in a residential environment. To this end, the present invention includes at least two embodiments: first where parcels are deposited into a first delivery station, which may often be located at or near a street similar to a mailbox, and delivered via underground tube to a second delivery station, which may be located at or inside a residence; second where parcels are deposited into a first delivery station and delivered via underground tube to a vault station and therefrom redirected from the vault station to one of a plurality of second delivery stations, which may be located at or inside a plurality of residences.

One object of the present invention is to allow easy access to the mail delivery system for handicapped and elderly persons or to persons who otherwise find it difficult to access the mail delivery system.

Another object of the invention is to provide enhanced security to automatic residential parcel delivery systems.

### BRIEF DESCRIPTION OF THE SEVERAL VIEWS OF THE DRAWING

A preferred embodiment of the present invention is described in detail below with reference to the attached drawing figures, wherein:

FIG. 1 illustrates the dual delivery station embodiment of the invention.

FIG. 2 illustrates the vault and multiple delivery station embodiment of the invention.

### DETAILED DESCRIPTION OF THE INVENTION

The embodiments discussed herein are merely illustrative of specific manners in which to make and use the invention and are not to be interpreted as limiting the scope of the instant invention.

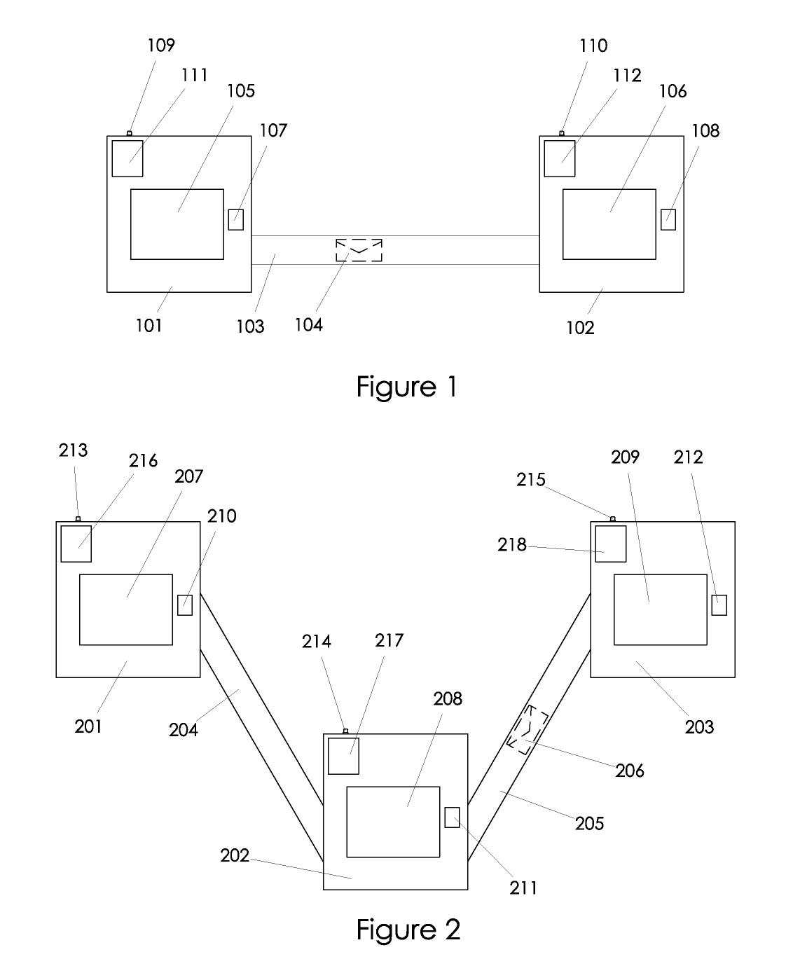

Referring to the drawings in detail, FIG. 1 illustrates the dual delivery station embodiment of the invention. A first delivery station 101 having an access door 105, locking mechanism 107, and visible light 109 and/or audible speaker 111 for indicating the presence or absence of a carrier 104 in the first delivery station. First delivery station 101 is connected to second delivery station 102 via a tube 103 through which a carrier 104 may be transported. Second delivery station 102 also has an access door 106, locking mechanism 108, and visible light 110 and/or audible speaker 112 for indicating the presence or absence of a carrier 104 in the second delivery station. Also included, but not shown is a means for transporting the carrier 104 back and for the between the first delivery station 101 and second delivery station 102. Transporting the carrier 104 may be accomplished by multiple means thoroughly discussed in prior art, including, but not necessarily limited to, pneumatically transporting and mechanically transporting via conveyor or the like. Detecting the presence or absence of the carrier 104 in the delivery stations may also be accomplished by multiple means thoroughly discussed in prior art, including, but not necessarily limited to, scales and movement sensors.

FIG. 2 illustrates the vault and multiple delivery station embodiment of the invention. A first delivery station 201 having an access door 207, locking mechanism 210, and visible light 213 and/or audible speaker 216 for indicating the presence or absence of a carrier 206 in the first delivery station. First delivery station 201 is connected to a vault station 202 via a tube 204 through which a carrier 206 may be transported. Vault station 202 also has an access door 208, locking mechanism 211, and visible light 214 and/or audible speaker 217 for indicating the presence or absence of a carrier 206 in the vault station. Vault station 202 is connected to second delivery station 203 via a tube 205 through which a carrier 206 may be transported. Second delivery station 203 also has an access door 209, locking mechanism 212, and visible light 215 and/or audible speaker 218 for indicating the presence or absence of a carrier 206 in the second delivery station. Also included, but not shown is a means for transporting the carrier 206 back and for the between the first delivery station 201, vault station 202, and second delivery station 203. Transporting the carrier 206 may be accomplished by multiple means thoroughly discussed in prior art, including, but not necessarily limited to, pneumatically transporting and mechanically transporting via conveyor or the like. Detecting the presence or absence of the carrier 206 in the delivery stations or vault station may also be accomplished by multiple means thoroughly discussed in prior art, including, but not necessarily limited to, scales and movement sensors.

The locking mechanisms of the various stations include, but are not necessarily limited to mechanical key locks, touch keypad locks, card reader locks, and scanner/bar code reader locks, each of which has been thoroughly discussed in prior art.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

The invention claimed is:

1. A parcel delivery system, comprising:
a carrier;
a first delivery station having an access door with a locking mechanism;
a second delivery station having an access door with a locking mechanism;
a tube connecting said first delivery station and said second delivery station wherein said carrier can be transported between said first delivery station and said second delivery station;
a means for transporting said carrier from said first delivery station to said second delivery station and for transporting said carrier from said second delivery station to said first delivery station;
a means for detecting the presence or absence of said carrier in said delivery stations;
a means for indicating the presence or absence of said carrier in said delivery stations.

2. The parcel delivery system of claim 1, wherein:
the delivery station access door locking mechanism is a mechanical key lock.

3. The parcel delivery system of claim 1, wherein:
the delivery station access door locking mechanism is a touch keypad lock.

4. The parcel delivery system of claim 1, wherein:
the delivery station access door locking mechanism is a card reader lock.

5. The parcel delivery system of claim 1, wherein:
the delivery station access door locking mechanism is a scanner/bar code reader lock.

6. A parcel delivery system, comprising:
a carrier;
a vault station having an access door with a locking mechanism;
a first delivery station having an access door with a locking mechanism;
a second delivery station having an access door with a locking mechanism;
a tube connecting said first delivery station and said vault station wherein said carrier can be transported between said first delivery station and said vault station;
a tube connecting said vault station and said second delivery station wherein said carrier can be transported between said vault station and said second delivery station;
a means for transporting said carrier from said first delivery station to said vault station and for transporting said carrier from said vault station to said first delivery station;
a means for transporting said carrier from said second delivery station to said vault station and for transporting said carrier from said vault station to said second delivery station;
a means for detecting the presence or absence of said carrier in said vault;
a means for detecting the presence or absence of said carrier in said delivery stations;
a means for indicating the presence or absence of said carrier in said vault;
a means for indicating the presence or absence of said carrier in said delivery stations.

7. The parcel delivery system of claim 6, wherein:
the delivery station access door locking mechanism is a mechanical key lock.

8. The parcel delivery system of claim 6, wherein:
the delivery station access door locking mechanism is a touch keypad lock.

9. The parcel delivery system of claim 6, wherein:
the delivery station access door locking mechanism is a card reader lock.

10. The parcel delivery system of claim 6, wherein:
the delivery station access door locking mechanism is a scanner/bar code reader lock.

11. The parcel delivery system of claim 6, wherein:
the vault station access door locking mechanism is a mechanical key lock.

12. The parcel delivery system of claim 6, wherein:
the vault station access door locking mechanism is a touch keypad lock.

13. The parcel delivery system of claim 6, wherein:
the vault station access door locking mechanism is a card reader lock.

14. The parcel delivery system of claim 6, wherein:
the vault station access door locking mechanism is a scanner/bar code reader lock.
